(19) United States
(12) Patent Application Publication
(10) Pub. No.: US 2026/0129388 A1
(43) Pub. Date: May 7, 2026

(54) System and Method for Synthesizing a Spatial Auditory Network via Ray-traced Multipath Sound Propagation

(71) Applicant: The Government of the United States of America, as represented by the Secretary of the Navy, Arlington, VA (US)

(72) Inventors: Steven M. Dennis, Covington, LA (US); Bradley M. Landreneau, Mandeville, LA (US); Christopher J. Michael, Covington, LA (US)

(73) Assignee: The Government of the United States of America, as represented by the Secretary of the Navy, Arlington, VA (US)

(21) Appl. No.: 18/939,946

(22) Filed: Nov. 7, 2024

Related U.S. Application Data
(60) Provisional application No. 63/596,722, filed on Nov. 7, 2023.

(51) Int. Cl. H04S 7/00; G06N 3/045

(52) U.S. Cl. CPC H04S 7/30; G06N 3/045; H04S 2400/11; H04S 2400/15

(57) ABSTRACT

A method of training a machine learning artificial intelligence system that includes generating scenario realizations each having a virtual spatial layout of sound-influencing features, and generating acoustic recordings of sounds moving through each scenario realization, where each acoustic recording is based on propagation effects associated with a corresponding virtual spatial layout. The method may include identifying isolated sounds in the acoustic recordings, and training a machine learning model comprising a multi-layer convolutional recurrent neural network (CRNN), with the one or more isolated sounds, wherein the training is via rectified linear unit (ReLU) activation and max pooling along a frequency axis, wherein the trained machine learning model generates output event activity probabilities. The method may include receiving a subsequent acoustic recording of one or more subsequent sound sources, and classifying, via the trained machine learning model, the one or more subsequent sound sources based on the generated output event activity probabilities.

### CROSS-REFERENCE

This application is a nonprovisional application of and claims the benefit of priority under 35 U.S.C. § 119 based on U.S. Provisional Patent Application No. 63/596,722 filed on Nov. 7, 2023. The Provisional Application and all references cited herein is hereby incorporated by reference into the present disclosure in their entirety.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, DC 20375, USA; +1.202.767.7230; nrltechtran@us.navy.mil, referencing Navy Case #211587.

### TECHNICAL FIELD

The present disclosure is related to machine learning, and more specifically to, but not limited to training a machine learning model via ray-traced multipath sound propagation.

### BACKGROUND

The subject of automatic detection and categorization of certain classes of sounds recorded by an auditory network is interesting and useful for several applications ranging from surveillance to mission planning. Modern supervised machine learning techniques are effective in other applications of automatic detection, but require very large amounts of highly curated information to yield favorable results. Unfortunately, no such dataset of curated auditory examples currently exists in the state of the art. In such situations, data synthesis may be used to rapidly create such a dataset without the need of costly field collection, staggering amounts of manual data labeling, and rigorous quality assurance.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present disclosure provides for a method of training a machine learning artificial intelligence system. The method may include generating, by a computing device, one or more scenario realizations, each scenario realization comprising a virtual spatial layout of one or more sound-influencing features. The method may include generating, by the computing device, a set of one or more acoustic recordings of one or more sounds moving through each scenario realization, the one or more sounds originating from a sound source in the scenario realization, wherein each acoustic recording is based on a set of one or more propagation effects associated with a corresponding virtual spatial layout of the one or more sound-influencing features, wherein each sound-influence feature causes an audio effect on the one or more sounds. The method may include identifying, by the computing device, one or more isolated sounds in the set of one or more acoustic recordings. The method may include training, by the computing device, a machine learning model comprising a multi-layer convolutional recurrent neural network (CRNN), with the one or more isolated sounds, wherein the training is via rectified linear unit (ReLU) activation and max pooling along a frequency axis, wherein the trained machine learning model generates output event activity probabilities. The method may include receiving, by the computing device, a subsequent acoustic recording of one or more subsequent sound sources. The method may include classifying, by the computing device, via the trained machine learning model, the one or more subsequent sound sources based on the generated output event activity probabilities.

### BRIEF DESCRIPTION OF THE DRAWINGS

FIG. 1 illustrates a block schematic illustration of an example flow diagram of a Spatial Auditory Network Dataset Synthesis (SANDS) embodiment in accordance with disclosed aspects.

FIG. 2 illustrates an example scenario realization in accordance with one or more disclosed aspects.

FIG. 3 illustrates an example scenario realization in accordance with one or more disclosed aspects.

FIG. 4 illustrates the Unity game engine and the Steam audio plugin examples in accordance with one or more disclosed aspects.

FIG. 5 illustrates a human-readable text file in accordance with one or more disclosed aspects.

FIG. 6 illustrates example sound recordings in accordance with one or more disclosed aspects.

FIG. 7 illustrates an example scenario realization in accordance with one or more disclosed aspects.

FIG. 8 illustrates an example scenario realization in accordance with one or more disclosed aspects.

FIG. 9 illustrates example sound recordings in accordance with one or more disclosed aspects.

FIG. 10 illustrates F-score, Precision, and Recall results in accordance with one or more disclosed aspects.

FIG. 11 illustrates the performance of the model as a function of the number of active sounds present in the scenario in accordance with one or more disclosed aspects.

FIG. 12 illustrates overall average signal to noise ratio (SNR) for each sound class in accordance with one or more disclosed aspects.

FIG. 13 illustrates the proportion of true positive vs. false negative predictions as a function of SNR in accordance with one or more disclosed aspects.

FIG. 14 illustrates an example, model performance as a function of the spatial relationship between recording and sound locations in accordance with one or more disclosed aspects.

FIG. 15 illustrates an example scenario realization in accordance with one or more disclosed aspects.

FIG. 16 illustrates an example scenario realization in accordance with one or more disclosed aspects.

FIG. 17 illustrates an example scenario realization in accordance with one or more disclosed aspects.

FIG. 18 illustrates an example scenario realization in accordance with one or more disclosed aspects.

FIG. 19 illustrates example sound recordings, associated labels, and associated frequencies in accordance with one or more disclosed aspects.

FIG. 20 illustrates example labels and frequencies in accordance with one or more disclosed aspects.

FIG. 21 illustrates example labels and frequencies in accordance with one or more disclosed aspects.

FIG. 22 illustrates example sound recordings in accordance with one or more disclosed aspects.

FIG. 23 illustrates example sound recordings in accordance with one or more disclosed aspects.

FIG. 24 illustrates example sound recordings in accordance with one or more disclosed aspects.

FIG. 25 illustrates an example method in accordance with one or more disclosed aspects.

FIG. 26 illustrates an example computer system in accordance with one or more disclosed aspects.

### DETAILED DESCRIPTION

The aspects and features of the present aspects summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

Disclosed embodiments provide for a system and method, which may be referred to as the Spatial Auditory Network Dataset Synthesis, or SANDS, environment, that can synthesize large datasets of dynamic, spatialized audio in realistic environments for the purpose of training machine learning (ML) classifiers for sound event detection (SED) applications.

Disclosed embodiments can synthesize multi-sound ensemble recordings to develop a methodology for fuzzy labeling each individual sound's relative contribution to the ensemble recording. For example, disclosed embodiments can model the movement and spatialization of multiple sound sources at once and synthesize a recording of combined sounds from the point of view of a listener position with all the auditory effects of the surrounding environment.

Disclosed embodiments can replay the scenario with each contributing sound source in isolation to be used in building the fuzzy labeling for that individual sound's contribution to the ensemble recording. Disclosed embodiments can build a labeled training set for future machine learning based applications. The fuzzy labeling quantifies the relative contribution of each individual sound to the overall ensemble recording. This may be based upon the spectral components of the spatialized sound to capture the unique frequency and time dependent signatures of each sound.

Previously, capturing large amounts of spatialized audio in a specific environment would require capturing actual field recordings of such events in the actual physical space. Doing so requires extensive amounts of planning and execution time, as well as expensive recording equipment and microphones to capture high quality audio. In addition, the labeling of the sound events captured during the recordings requires extensive manual effort and expertise, and is often error prone.

Scaper is a synthesis tool for generating and annotating large datasets for sound event detection (SED ML applications. One difference between Scaper and SANDS is that SANDS produces physically modeled, spatialized audio in a user-defined 3-D environment, whereas Scaper does sound mixing to combine sounds into synthesized soundscapes and cannot model physical acoustic interactions with the environment.

Three dimensional virtual models of the environment are made in the user's modeling program of choice and imported into the Unity game engine editor. Within the Unity Editor, the environmental geometry is tagged with physical-acoustic material properties using the Steam Audio plugin for Unity. The SANDS provided Unity scripts and scene objects are then incorporated into the Unity scene to provide out dataset synthesis capabilities to the Unity game engine. The Unity project is then built for use by the SANDS audio scenario and dataset synthesis tools.

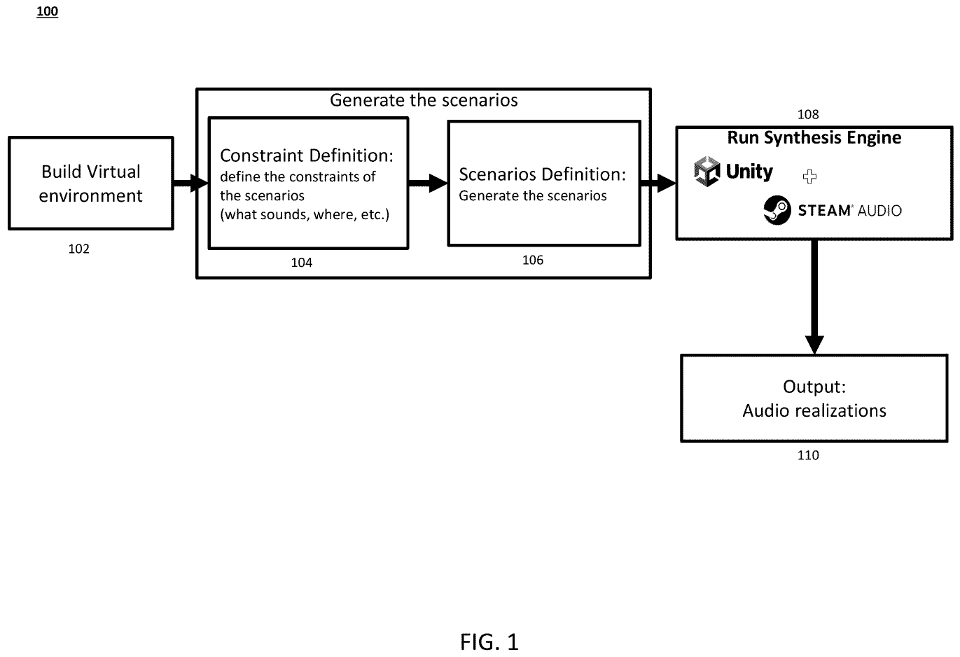

FIG. 1 illustrates a block schematic illustration an example flow diagram 100 for one or more disclosed aspects of the SANDS embodiments. In step 102, a virtual environment can be built, where parameters controlling the various audio scenarios to be synthesized within the built Unity environment can defined. In steps 104 and 106, one or more scenarios (sometimes referred to as scenario realizations) can be generated. For example, the scenarios can be generated in a YAML scenario definition file. In one example, SANDS Python code reads the scenario definition file and generates a user specified number of scenarios to synthesize. The SANDS synthesis engine (step 108) can use the Unity environment to realize audio for each scenario, generating one or more spatialized sound files (step 110) for the entire scenario (the ensemble recording) and/or one or more isolated spatial recordings of one or more constituent sound sources of the scenario (the isolated recordings).

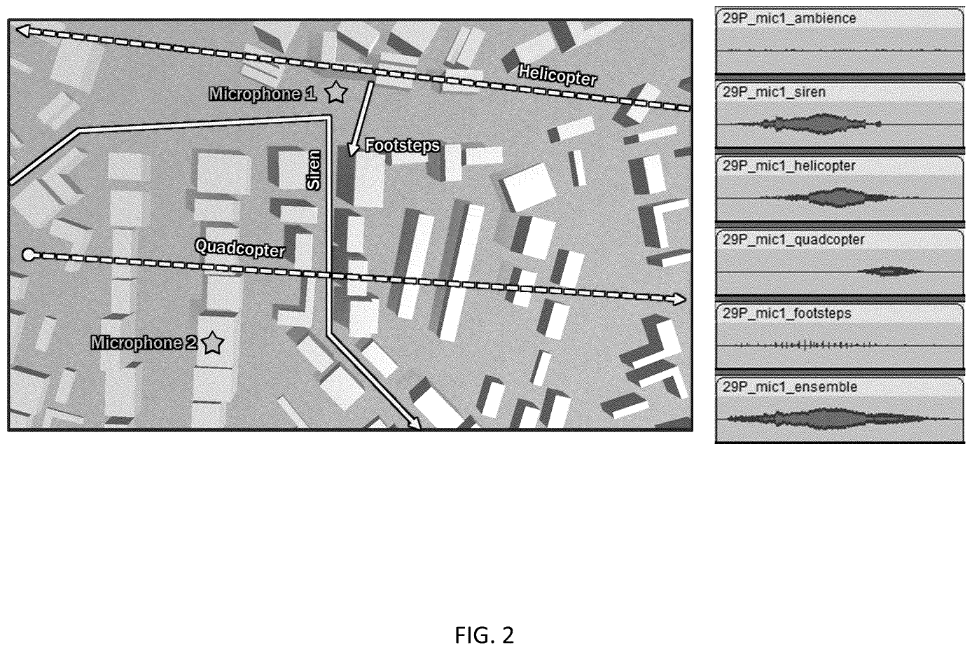

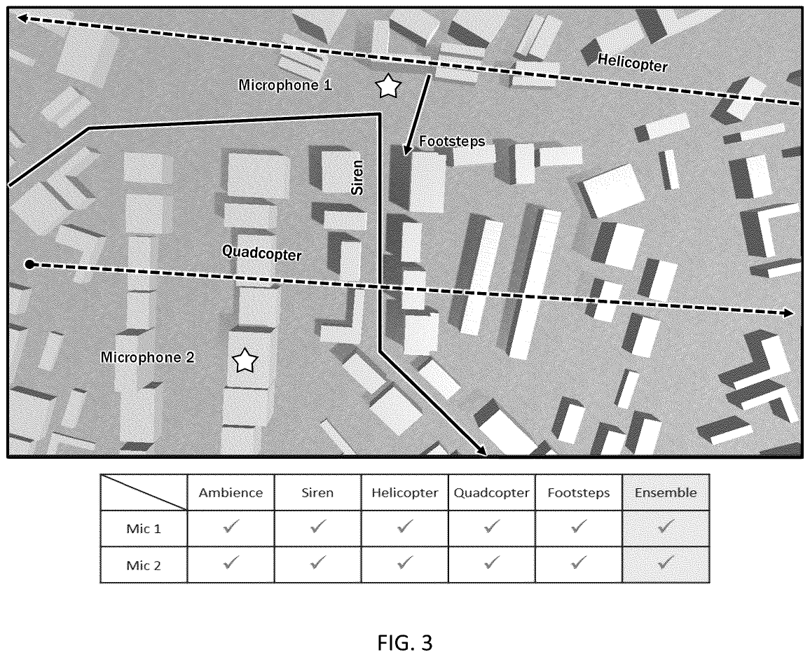

Example scenario realizations can be seen in FIGS. 2 and 3, indicating sound source paths (lines) and listener positions (stars). Also shown are some sound-influencing features and sound sources, such as ambience, siren, helicopter, quadcopter, footsteps, microphones, and/or the like. In some embodiments, a sound recording for each identified sound may be generated based on the scenario, such as shown in FIG. 2.

Once dataset synthesis is complete, SANDS Python code will automatically produce sample accurate annotations of every sound event in every ensemble file. The ensemble sound files and the associated sound event annotations are then packaged up into a standard format, flat dataset structure that can be used directly for training, validating and testing any ML classifier implementation for SED applications, such as security and safety solutions in private or public areas.

SANDS allow for the synthesis of very large and varied datasets for a fraction of the material and time costs associated with traditional field recording techniques for capturing spatialized sound events.

Because SANDS can be an entirely virtual synthesis process, in some embodiments, a user can be free to produce recordings for any number of scenario setups, where the user may be limited by time or material availability, or location access, when using traditional recording methods.

Annotation of sound events is automatic and sample accurate with SANDS, whereas the process of annotation is time consuming and error prone when done manually.

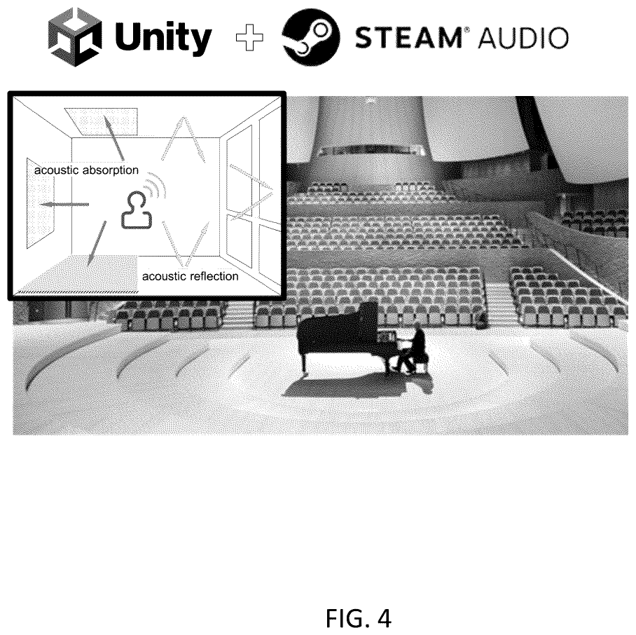

The Spatial Auditory Network Dataset Synthesis, or SANDS, environment provides a technique for rapidly synthesizing auditory network data using modern-day 3D game development libraries. Use of these products bypasses the necessity of building an environmental acoustic model, which would take many years of labor. A combination of the Unity game engine and the Steam audio plugin are used to virtualize sound propagation using ray-traced multipath sound propagation that simulates occlusion, reflection, transmission, scattering, absorption, reverberation, and Doppler effects (FIG. 4).

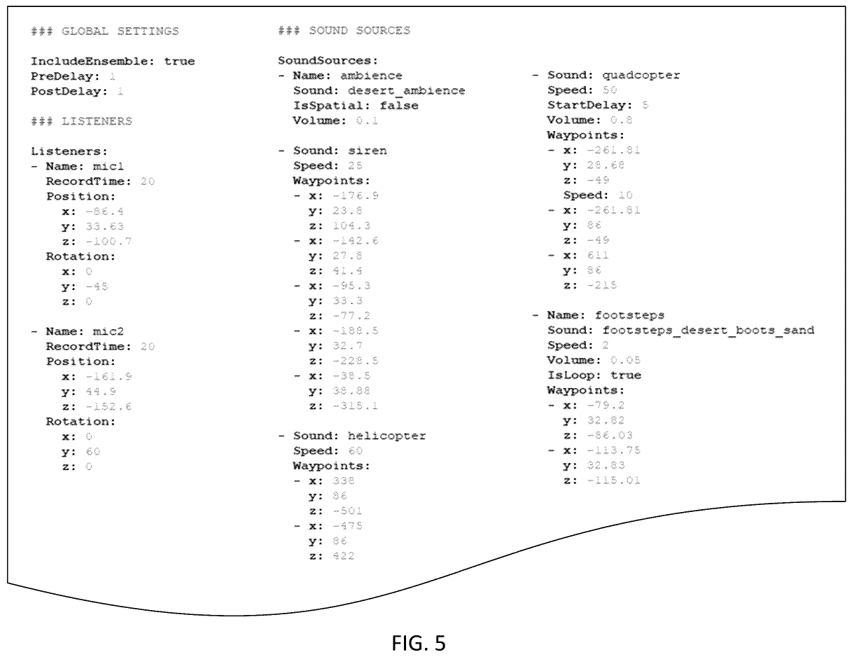

Use of SANDS involves the creation of a 3D environment using the Unity engine. Each object within the environment is tagged with its physical attributes as they apply the object's interaction with sound. After the environment is created, the SANDS API may be used to create a scenario. Scenarios can be defined using a human-readable text file that specifies the location of listeners, sound sources, tracks of sound sources, ambiance, and/or the like, an example of which can be seen in FIG. 5.

SANDS provides the capability to synthesize large datasets of spatialized audio recordings that may be used for the training, validation and testing of deep learning models for sound event detection applications.

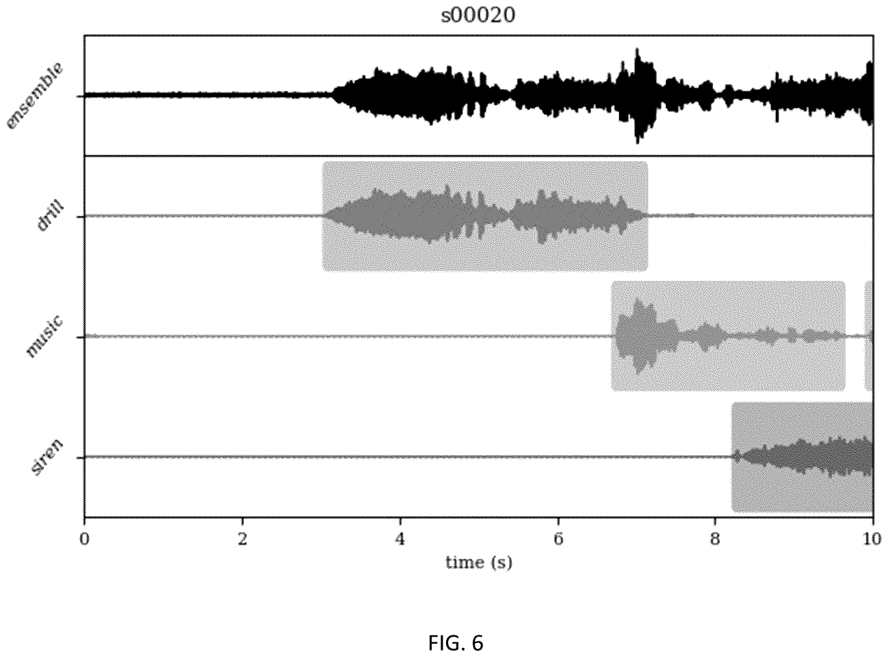

FIG. 6 illustrates example sound recordings in accordance with disclosed aspects, which may be output by SANDS and used to train a machine learning model to identify subsequent sounds. In some embodiments, SANDS provides isolated spatialized audio from individual sound sources which allows for automated, sample accurate strong labeling of sound events that would be impossible with real audio recordings. SANDS allows for the capturing of realistic environmental acoustic responses with a level of detail and quantity that would be nearly impossible to achieve with real-world recordings.

In some embodiments, SANDS can generate curated output in many forms, such as the following examples (in addition to other forms and types):

1. An ensemble audio file from each sound source that contains all sound sources of the scenario.

2. An audio file containing the ambient sound devoid of other sound sources during the scenario.

3. A group of audio files, one from each sound source, containing only the respective sound source isolated during the scenario.

The SANDS output allows for robust labeling at the time-frequency level at the end-user's discretion. The isolated source output files may be compared against the ensemble to determine each source's contribution to the overall soundscape.

In some embodiments scenarios are defined through a human-readable text file. Disclosed embodiments may include fully customizable scenarios for sensors, sources, and environment. Some embodiments may include the following features:
Per Listener Record Times
Background Ambience (non-spatial)
Route Speed with Waypoint Override
Route Start Offset
Looping Routes
Sound Volume Control

In some embodiments, SANDS can be constructed from a combination of the Unity game engine and the Steam Audio plugin along with custom Unity scripting code to turn 3-D scene models and scenario definitions into synthesized realizations of audio recordings of sound events. These synthesized recordings, over many scenarios, represent the acoustic response expected from the environment, and can be used in training ML classifiers.

### Unity Project Preparation

In some embodiments, the following may be included:

The SteamAudio Unity plugin may be installed and enabled for the Unity project. Instructions can be found at the SteamAudio website: https://valvesoftware.github.io/steam-audio/.

The YamlDotNet package is available for free from the Unity Asset Store. See https://assetstore.unity.com/packages/tools/integration/yamldotnet-for-unity-36292 for more details.

The SANDS Unity script files (AudioRenderer.cs, MainController.cs and Scenario.cs) may be present in the projectAssets folder (Assets/SANDS recommended).

### Scene Characteristics

Follow normal SteamAudio procedures for tagging your scene geometry with acoustic properties. Documentation for preparing your scene for SteamAudio in Unity can be found at https://valvesoftware.github.io/steamaudio/doc/unity/guide.html.

SANDS can include a single GameObject named SoundSource to act as the prototype for all the Sound Sources in a SANDS scenario. Add an Audio Source component to SoundSource and configure the settings as desired. There is might not been the need to set an Audio Clip to SoundSource. During SANDS synthesis, the scenario audio clips will be assigned for you. The Volume and Spatial Blend parameters can be automatically set as needed by the SANDS scenario. Add a Steam Audio Source component to SoundSource and configure the settings as desired for the scenario. You can optionally attach a single child object to SoundSource to be used as a visual indicator of when the associated sound is playing. SANDS may include a single GameObject named Listener to act as the prototype Listener in a SANDS scenario. The following components may be added to Listener: Audio Listener, Steam Audio Listener, Main Controller (Script), and Audio Renderer (Script). Configure the settings of the Steam Audio

Listener component as desired for the scenario.

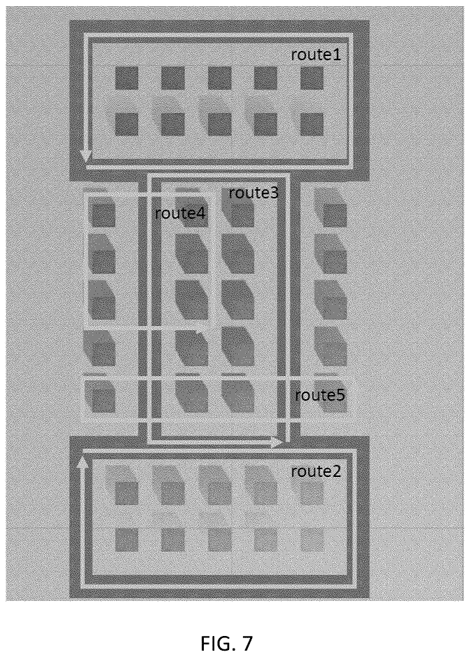

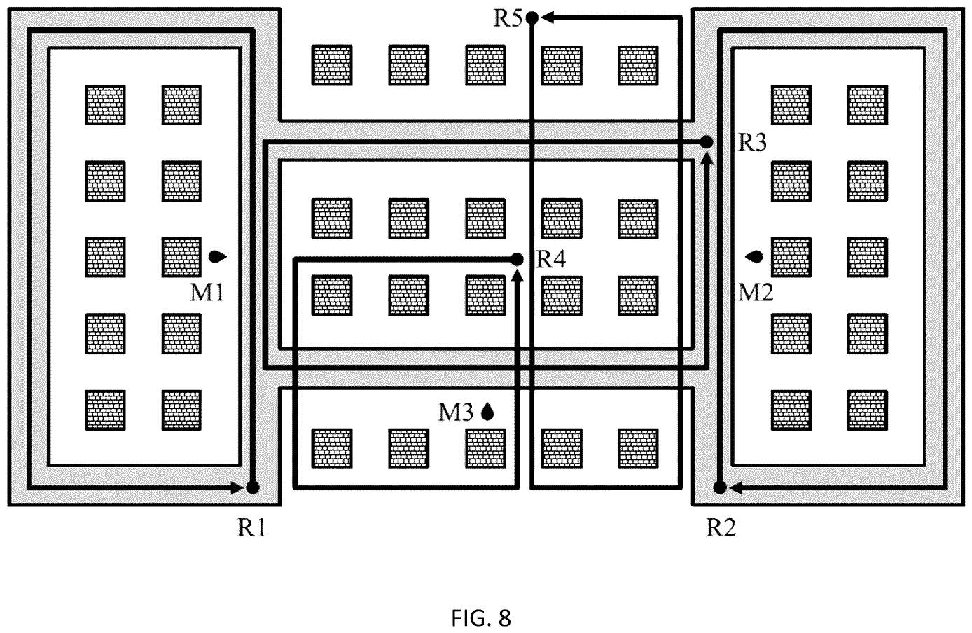

FIG. 7 illustrates an example scenario realization, which may include grass, concrete roads, brick houses, and the like. FIG. 8 illustrates example locations of routes (R1, R2, R3, R4, R5) and recording devices (M1, M2, M3). This scenario realization may include:

### Scenario Elements:

4 Target Sounds
3 Listening Positions
2 Ambience Variations
5 Possible Routes

Scenarios for all combinations:
1-4 Active Sounds
Ambiences
Routes

Produce Ensemble+Isolated audio for:
All Listening Positions
Randomized Speeds
Randomized Start Delay
1000 Scenarios
3000 Ensemble Recordings
˜33 hours of audio (10 sec clips)

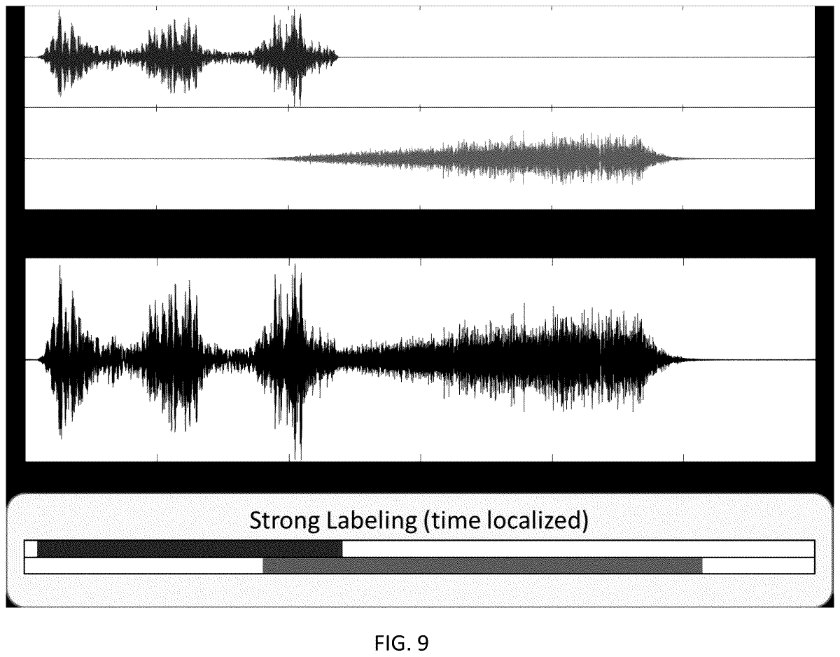

FIG. 9 illustrates example sound recordings. In some cases, strong labels contain temporal information for each sound class, such as onset/offset times. In some cases, polyphonic labels allow for the presence of multiple classes at any given time. Disclosed embodiments can isolate components of each active sound class. SANDS allows for higher level of event detection through time localization. Synthetic datasets allow for fast and accurate production of strongly labeled audio.

### Scenario Definition

Disclosed embodiments provide for defining scenarios (Scenario definition) using, in one example, a YAML formatted text file. Input fields are in the form of key-value pairs, with input field keys being case sensitive. Standard YAML formatting applies, with new lines indicating the end of a field, indentation with spaces indicating nesting of fields and list elements beginning with a dash. More details on the YAML format can found at https://yaml.org.

By default, SANDS will attempt to load a scenario from the file Assets/StreamingAssets/scenario.yaml. When launching SANDS from the standalone Unity Player, you can provide a custom path to your scenario input file with the following command line argument:

<BuildName>.exe-i path/to/scenario.yaml

The following tables detail the input fields and structure of the SANDS scenario file. If omitted, values will take on the noted default values. Values without noted defaults should be considered.

### Global Settings

| Key | Value | Notes |
|---|---|---|
| IncludeEnsemble | Boolean | A value of true synthesizes |
| | (default: true) | an ensemble recording of all |
| | | Sound Sources playing for |
| | | each Listener. |
| | | A value of false omits the |
| | | ensemble synthesis. |
| SoundsDirectory | String (default: | Path to the folder containing |
| | StreamingAssets/ | the .wav files for the Sound |
| | sounds) | Sources. |
| OutputDirectory | String (default: | Path to the folder where the |
| | StreamingAssets/ | output .wav files will be |
| | output) | written. |
| PreDelay | Number (default: 0) | Pre/PostDelay sets the amount of |
| PostDelay | Number (default: 0) | silence (in seconds) to include |
| | | before/after each synthesized |
| | | recording. |

### Listeners

| Key | Value | Notes |
|---|---|---|
| Listeners | List | A list of Listener elements. |

Listener Elements

| | | |
|---|---|---|
| Name | String | Identifier for this Listener. |
| RecordTime | Number | The amount of time (in seconds) to |
| | (default: 0) | synthesize audio for this Listener. |
| Position | | |
| x | Number | Defines the position of this |
| y | Number | Listener in the Unity scene |
| z | Number | using the coordinates (x, y, z). |
| Rotation | | |
| x | Number | Defines the orientation of |
| y | Number | this Listener in the Unity scene |
| z | Number | using the Euler angle rotations (x, y, z). |

### Sound Sources

| Key | Value | Notes |
|---|---|---|
| SoundSources | List | A list of Sound Source elements. |

Sound Source Elements

| | | |
|---|---|---|
| Name | String | Identifier for this Sound Source. |
| | | If omitted, the sound filename (see |
| | | below) will be used. |
| StartDelay | Number | The amount of time (in seconds) to |
| | (default: 0) | delay the start of this Sound Source's |
| | | audio and movement. |
| Sound | String | The filename, without path or .wav |
| | | extension, specifying the sound file |
| | | to play for this Sound Source. |
| Volume | Number | A value between 0 and 1 that indicated |
| | (default: 1) | the playback volume of the sound. |
| | | Values of 0 and 1 indicated silence |
| | | and full volume respectively. |
| IsSpatial | Boolean | A value of true enables spatial |
| | (default: true) | processing of the Sound Source. |
| | | A value of false disables all spatial |
| | | processing, with no environmental |
| | | effects,or effects from the positioning |
| | | of the Sound Source and the Listener. |
| | | This is useful for background ambience |
| | | sounds that are to be considered |
| | | distant or already spatialized and |
| | | should be recorded as-is by the |
| | | Listeners. |
| Route | | The following fields define this |
| | | Sound Source's motion through |
| | | the Unity scene. |
| Speed | Number | The pre-defined speed (in Unity units |
| | (default: 0) | per second) of the Sound Source's |
| | | movement along this route. |
| | | This value will be the default speed |
| | | for any Waypoints that do not |
| | | explicitly provide their own speed. |
| IsLoop | Boolean | A value of true Indicates that the |
| | (default: false) | Sound Source will travel from the |
| | | last Waypoint back to the first |
| | | Waypoint and repeat the Route |
| | | indefinitely. |
| | | A value of false indicates that The |
| | | Sound Source should stop at the |
| | | final Waypoint if it is reached. |
| Waypoints | List | A list of Waypoints defining the |
| | | Sound Sources movement through |
| | | the Unity scene. |
| x | Number | Defines the position of this Waypoint |
| y | Number | in the Unity scene using the coordinates |
| z | Number | (x, y, z). |
| Speed | Number | Defines the speed that the Sound Source |
| | (default: noted) | will move to the next Waypoint. |
| | | If not specified, the pre-defined Route |
| | | speed (see above) will be used. |

The following is an example scenario definition file:

### Example Scenario Definition File

| ### GLOBAL SETTINGS | |
|---|---|
| SoundsDirectory: C:\SANDS\sounds | |
| OutputDirectory: C:\SANDS\output | |
| IncludeEnsemble: true | |
| PreDelay: 1 | |
| PostDelay: 1 | |
| ### LISTENERS | |
| Listeners: | |
| - | Name: mic1 |
| | Recordline: 20 |
| | Position: |
| | x: −86. [symbol] |
| | y: 33.63 |
| | z: −1 [symbol] .7 |
| | Rotation: |
| | x: [symbol] |
| | y: −45 |
| | z: [symbol] |
| - | Name: mic2 |
| | Recordline: 20 |
| | Position: |
| | x: −161.9 |
| | y: [symbol] .9 |
| | z: −152.5 |
| | Rotation: |
| | x: [symbol] |
| | y: [symbol] |
| | z: [symbol] |
| ### SOUND SOURCES | |
| SoundSources: | |
| - | Name: ambience |
| | Sound: desert_ambience |
| | IsSpatial: false |
| | Volume: 0. [symbol] |
| - | Sound: siren |
| | Route: |
| | Speed: 25 |
| | Waypoints: |

| | |
|---|---|
| - | x: −175.9 |
| | y: 23. [symbol] |
| | z: 10 [symbol] .3 |
| - | x: −1 [symbol] 2.6 |
| | y: 27.8 |
| | z: [symbol] |
| - | x: −95.3 |
| | y: 33.3 |
| | z: −77.2 |
| - | x: −1 [symbol] .5 |
| | y: 32.7 |
| | z: −228.5 |
| - | x: −38.5 |
| | y: 38. [symbol] 8 |
| | z: −315. [symbol] |

| | |
|---|---|
| - | Sound: helicopter |
| | Route: |
| | Speed: 60 |
| | Waypoints: |

| | |
|---|---|
| - | x: 338 |
| | y: 86 |
| | z: −5 [symbol] |
| - | x: − [symbol] 75 |
| | y: 86 |
| | z: [symbol] 22 |

| | |
|---|---|
| - | Sound: quadcopter |
| | StartDelay: 5 |
| | Volume: [symbol] .8 |
| | Route: |
| | Speed: 50 |
| | Waypoints: |

| | |
|---|---|
| - | x: −261.8 [symbol] |
| | y: 28.6 [symbol] |
| | z: −49 |
| | Speed: 10 |
| - | x: −261.81 |
| | y: 56 |
| | z: −49 |
| - | x: 611 |
| | y: [symbol] |
| | z: −215 |

| | |
|---|---|
| - | Name: footsteps |
| | Sound: footsteps_desert_boots_sand |
| | Volume: [symbol] .95 |
| | Route: |
| | Speed: 2 |
| | IsLoop: true |
| | Waypoints: |

| | |
|---|---|
| - | x: −79.2 |
| | y: 32. [symbol] 2 |
| | z: −86. [symbol] 3 |
| - | x: −113.75 |
| | y: 32. [symbol] 3 |
| | z: −115. [symbol] 1 |

[symbol]

indicates data missing or illegible when filed

### 2 Spatial Auditory Network Dataset

In one reduction to practice example, the Spatial Auditory Network Dataset may contain about 12,000 realizations of up to five of 12 sound sources moving through a virtual residential neighborhood environment. The environment was modeled and tagged with appropriate acoustic properties in Unity to approximate interaction with brick houses, concrete roads, and grass ground cover. Within the environment, five routes were defined for sound sources to move along during synthesis. Each route has a predefined starting point, and form closed loops for situations where an object reaches the end of a route before recording of the realization has ended.

The Steam Audio plugin provides the mechanism through which the Unity engine simulates the interaction of sound with the scene geometry as it propagates from the source to the recording position. FIG. 8 illustrates an example of a modeled environment, the movement routes, and the recording locations. Twelve (12) sound classes were chosen for a mix of both natural and mechanical sounds. Sound samples for the classes, along with three background ambience sounds were downloaded from Freesound[2] and trimmed down to four second clips.

Each realization was constructed by first randomly choosing one of three predetermined recording locations, and one of three possible background ambiences. Next, between one and five of the sound classes are randomly chosen for inclusion in this realization. Each active sound class is randomly assigned one of the five possible movement routes, such that each active sound class is on a different route. For each active sound class, a random start delay is assigned. The start delay controls how long after the start of the realization that sound class will begin playing and moving, and is chosen uniformly randomly between zero and nine seconds. Each active sound source can be randomly assigned a movement speed. This speed can be between zero (stationary) to some maximum speed determined by the specific sound class. The assigned speed is constant, and each active sound class will move at its respective randomized speed once started. The position of an active sound class is therefore determined by linear interpolation along the assigned route using its given speed and start time.

In one example, each realization contains 10 seconds of active recording, with a 0.25 second buffer of silence before and after, resulting in 10.5 seconds total of binaural audio. The primary audio output of a realization is the ensemble audio. The ensemble audio file represents the fully realized representation of what was recorded from the recording position, taking into account the sound from the active classes interacting with the modeled environment as it propagates to the recording position, and the background ambience sound. In addition, SANDS can produce isolation or iso audio files. Each active sound class, and the background ambience, are synthesized individually, maintaining the environmental effects on their sound propagation. These iso files are most useful for automatically producing sample accurate, ground truth sound event labeling. Strongly labeling such a large dataset with only the ensemble audio, manually or through an automated process, would be much too labor intensive or error prone. Having access to isolated audio for each contribution to the overall ensemble makes this dataset unique in the field of environmental audio, and would not be possible with real-life recordings.

In some embodiments, from each recording position, the following may be example output:
Isolated recording of each spatialized sound
Isolated recording of background ambience
Ensemble recording of all spatialized and ambient sound

In some embodiments, ensemble represents “real world” recording, and isolated recordings may be a basis for training ML classifier.

### 3 Example Experiment

The 12,000 synthesized ensemble clips of the dataset were partitioned into training, validation and testing subsets using an 80-10-10% split respectively. Ground truth strong labeling was generated for each ten second ensemble clip based upon the isolated clips for each sound class. A sound is considered to be present in the isolated clip if the level exceeds −60 dBFS. The start and end times of a block of continuous sound defines a single sound event of that class. Any gap between events that is less than 150 ms is ignored and the two events are merged into a single event. Additionally, any event with a duration less than 250 ms is ignored. This follows the guidelines for defining strong sound event labels used for the DCASE 2022 Challenge.[1] A state-of-the-art model, based upon the multi-label convolutional recurrent neural network (CRNN) architecture proposed by Cakir et al.[5], was implemented in PyTorch. The model can include three convolutional layers with rectified linear unit (ReLU) activation and max pooling along the frequency axis. The output of the convolutional layers can then stacked and fed into recurrent layers before a forward feed layer with sigmoid activation produces the output event activity probabilities. Binary event activity predictions are produced by thresholding the output probabilities at a threshold, such as in some embodiments at 0.5. Other values may be used. The resulting model has 4 million trainable parameters. The CRNN was trained with spectrograms having 40 log mel band energies over 501 time frames and the associated ground truth labeling. Training used the Adam optimizer[3] with a binary cross-entropy loss function, terminating after at least 100 epochs when there failed to be an improvement in the segment-based F-score[4] of the validation set. The trained model provides predictions of class presence in the ensemble soundscape at the time resolution of the input spectrogram, approximately 200 milliseconds per analysis frame.

In some cases, strong labels contain temporal information for each sound class, such as onset/offset times. In some cases, polyphonic labels allow for the presence of multiple classes at any given time. Disclosed embodiments can isolate components of each active sound class.

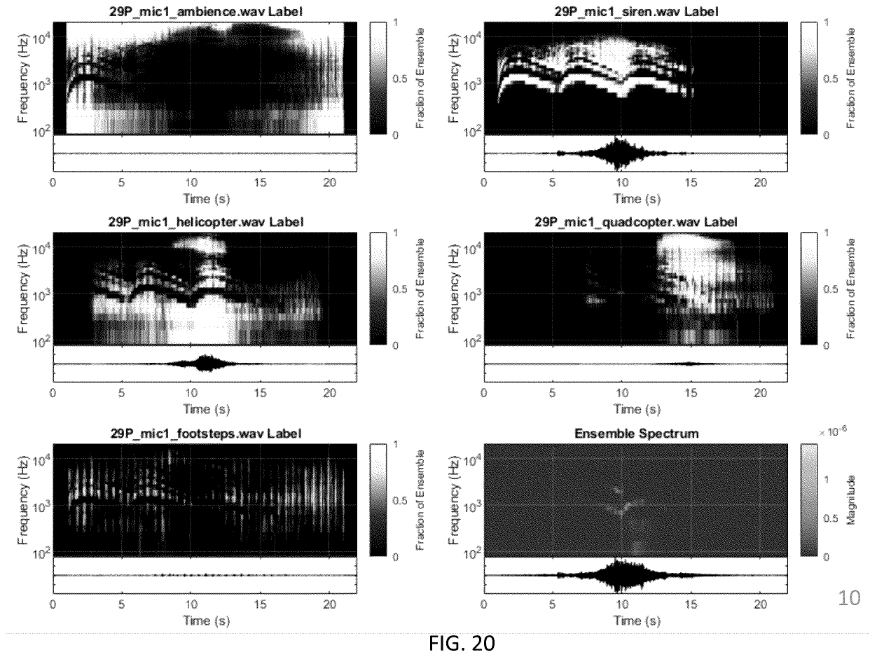

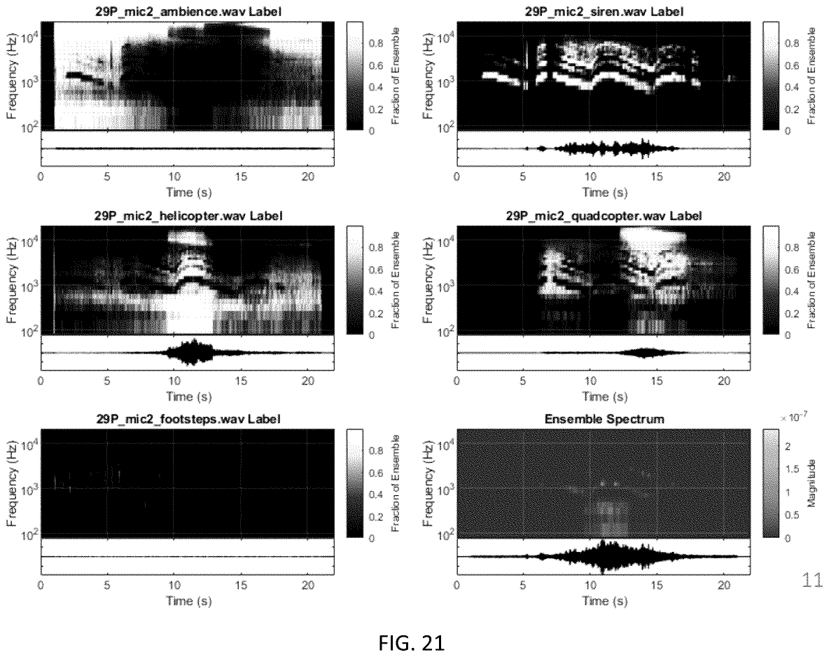

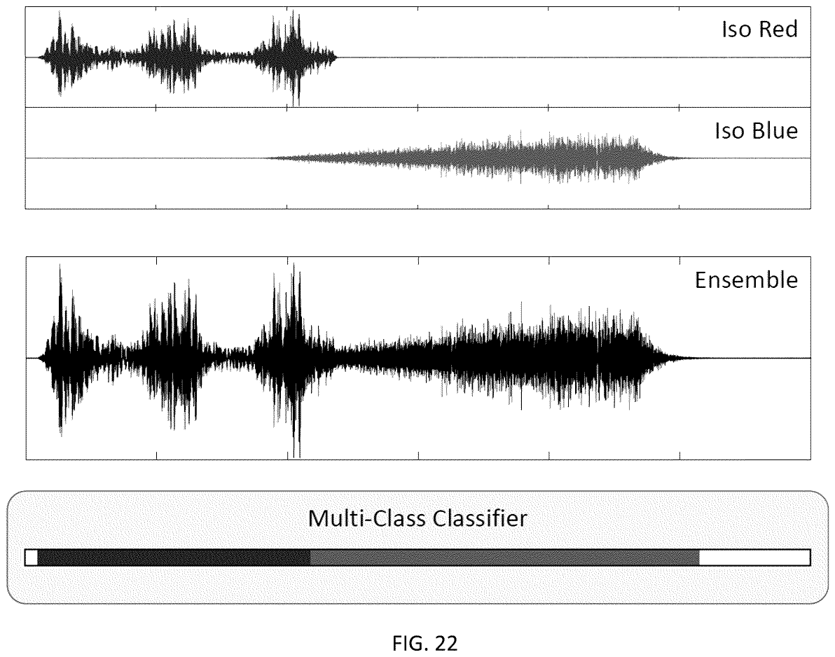

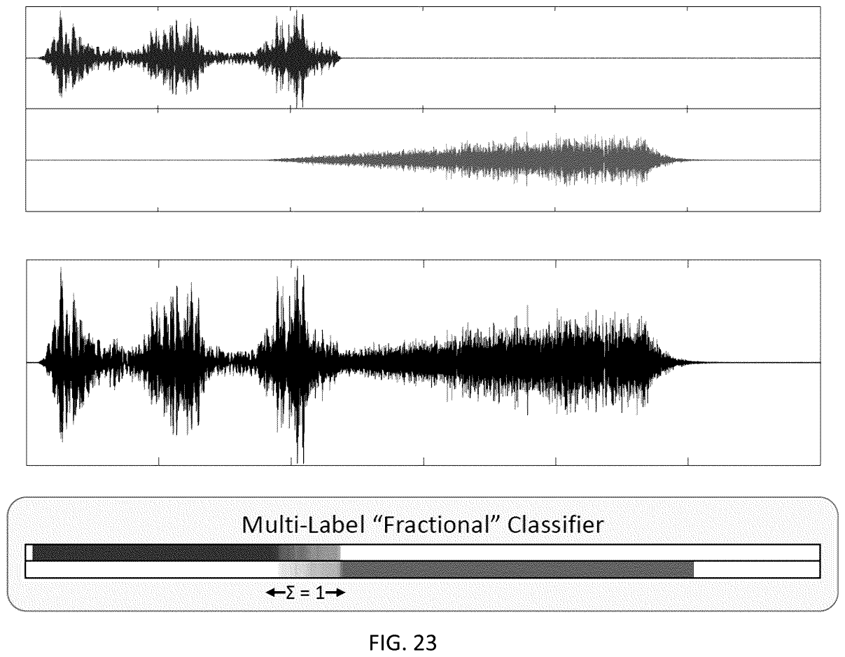

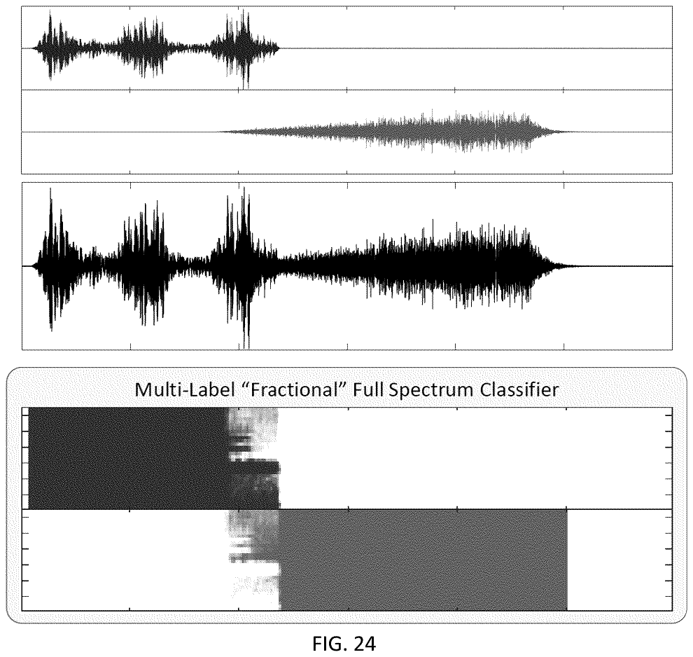

Multiclass Labeling quantifies each individual sound's contribution to the overall ensemble soundscape. Labeling is done on a high resolution time and frequency basis, providing fine grained information. These labels can be used to train a classifier to identify similar sounds in subsequent sound recordings (see FIGS. 20-24).

### 4 Results

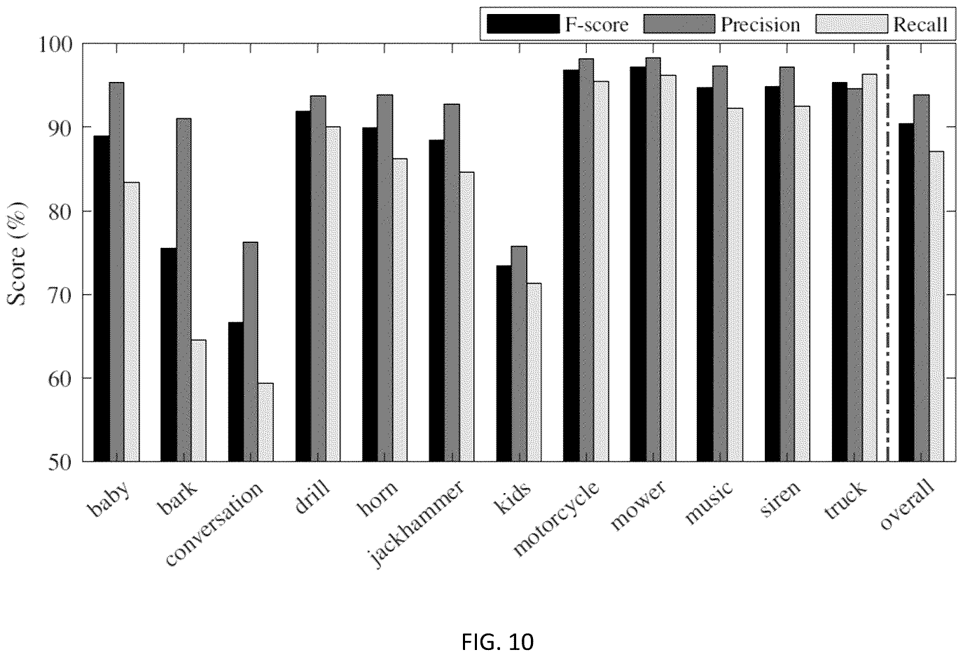

Model performance metrics were calculated using the open source software toolbox sed eval[4]. F-score, Precision, and Recall results for each sound class across the 12,000 scenarios in the test subset are shown in FIG. 10 (showing model scores for each sound class). Overall model performance was very high, with an F-score above 90%. Variation in performance with respect to sound class was observed, with some of the more difficult classes (dog barking, conversation, kids playing) scoring below 80%. In the case of bark and conversation it can be seen that precision remained relatively high, while recall was more greatly diminished, indicating that these sounds were generally present when the model predicted presence, but also allowed these sounds to go unnoticed more often.

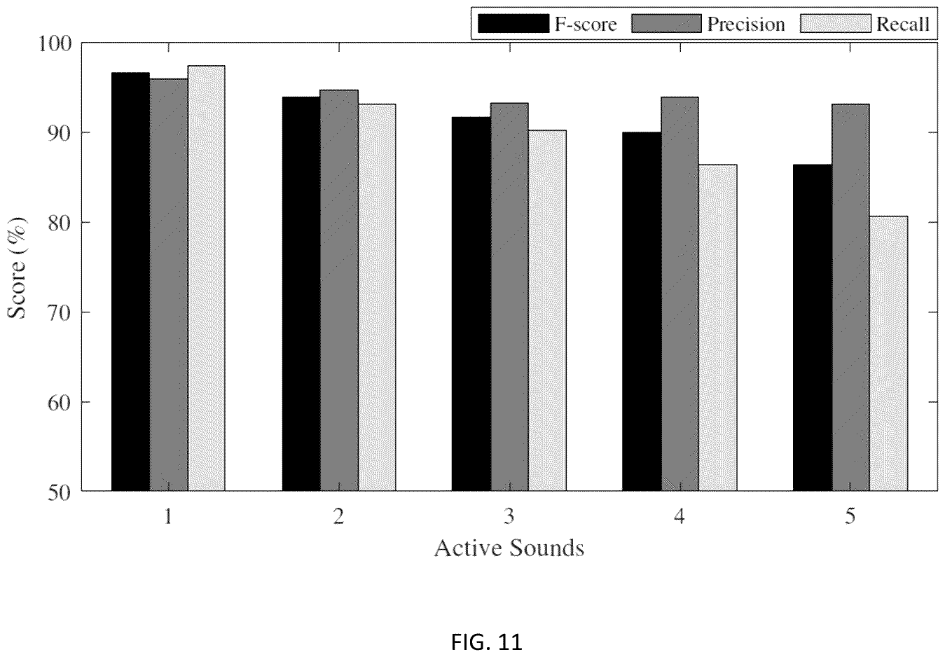

FIG. 11 shows the performance of the model as a function of the number of active sounds present in the scenario. F-scores exhibit a near linear decline as the number of active sounds increases, however, precision remains more consistent. The implication is that more active sounds tends to mask the model's ability to detect some events, but the detections that are made remain accurate. This is especially true of the quieter sound classes that are more likely to have diminished signal-to-noise ratios (SNR) when present with louder sounds in a scenario.

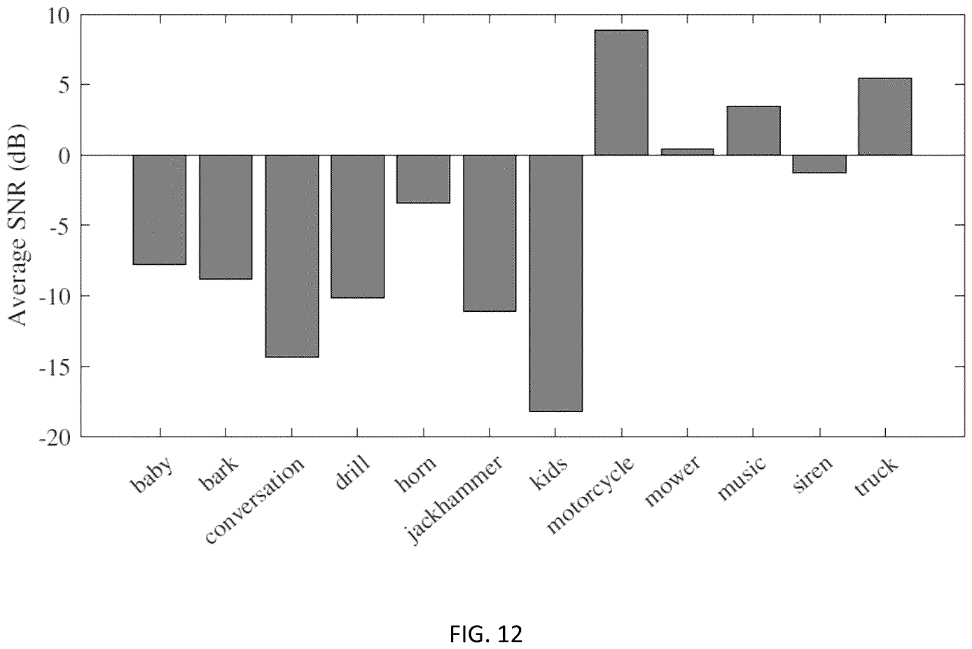

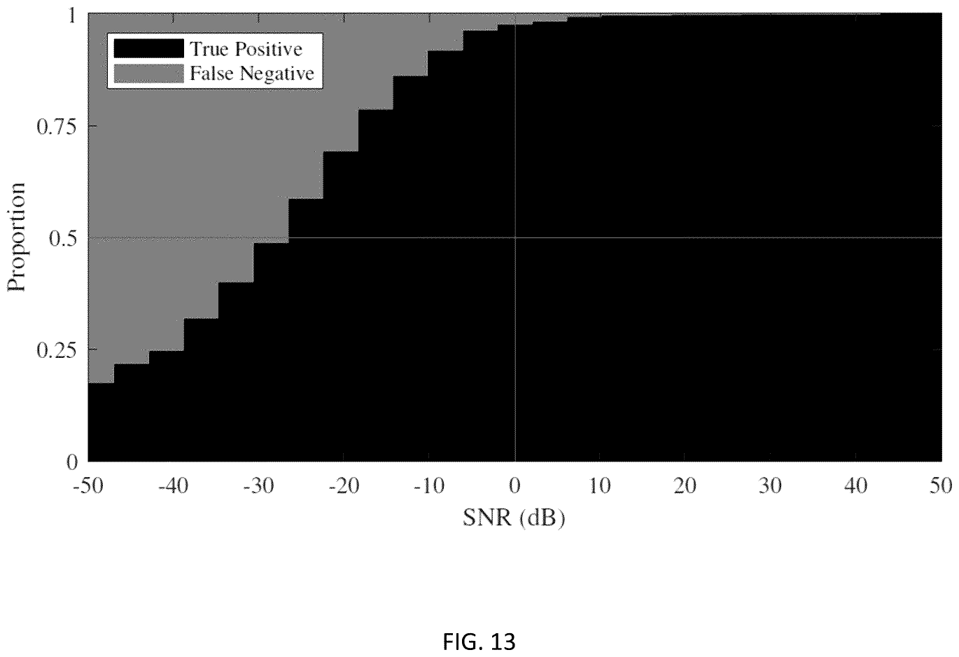

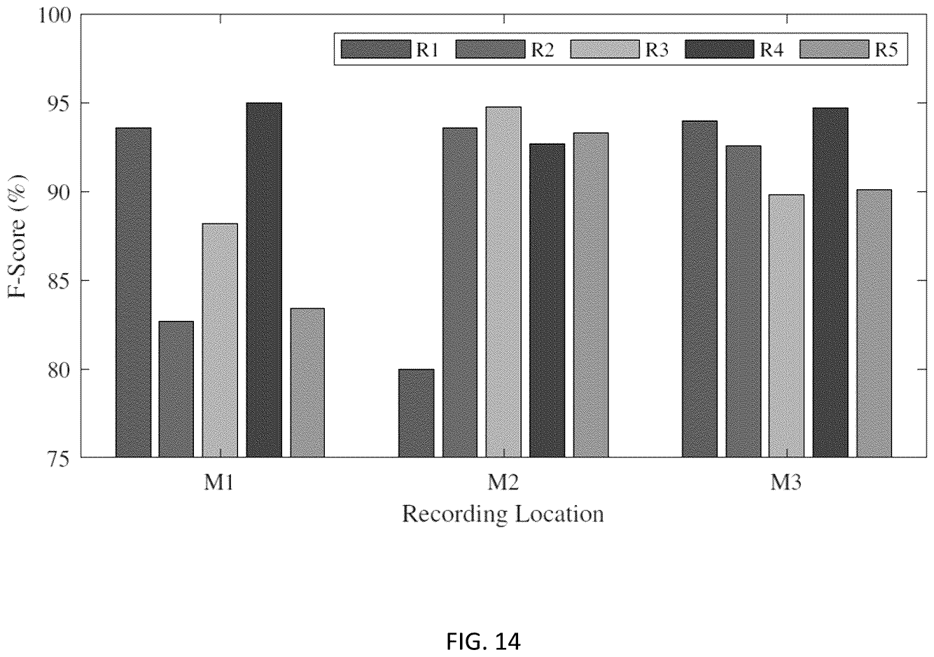

SNR is calculated for each analysis frame in which a class has ground truth presence as the ratio of the sound class level to the combined level of all other sounds present in that frame. The overall average SNR for each sound class is shown FIG. 12. In general, most individual sounds are present in scenarios at an SNR deficit, acoustically masked by the other sounds. The motorcycle, mower, music, and truck tended to be the loudest sounds in scenarios in which they were present. Despite the SNR disadvantage that most sounds incurred, the model maintained the ability to make true positive identifications well into the noise level. The proportion of true positive vs. false negative predictions as a function of SNR is shown in FIG. 13. Because this dataset is synthesized with respect to a modeled physical environment, there is the possibility to analyze model performance with respect to physical aspects of the scenario geometry. As an example, model performance as a function of the spatial relationship between recording and sound locations is shown in FIG. 14. An inverse relationship between distance to sound and recording location becomes obvious when cross-referencing these results with the general scenario layout in FIG. 8. This type of physical analysis would not be possible with real world recordings without detailed documentation of sound source and recording locations and the physical environment. Producing such a real-world dataset for SED model training is infeasible. Even other synthesis techniques that utilize mathematical manipulation and sound mixing would not allow for this level of physical interpretation.

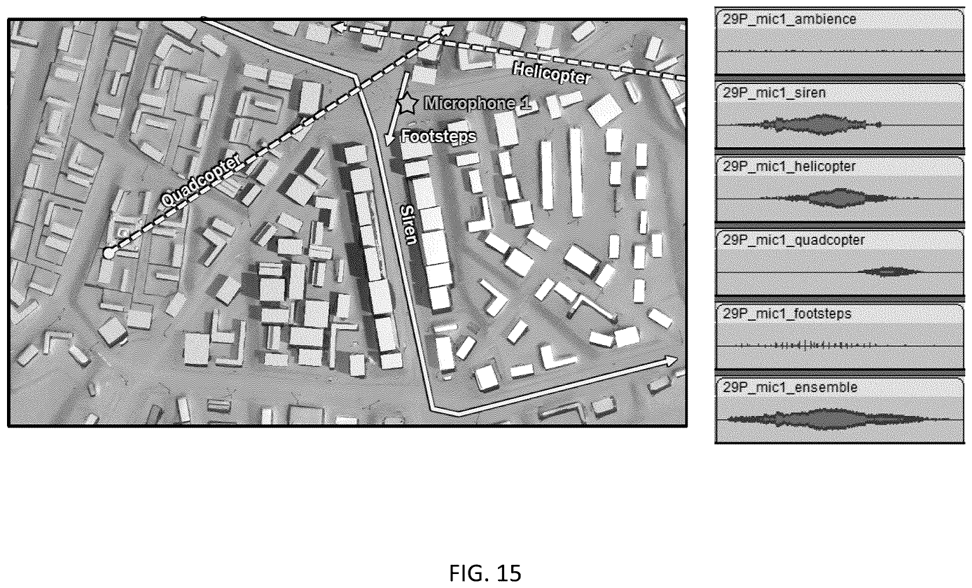

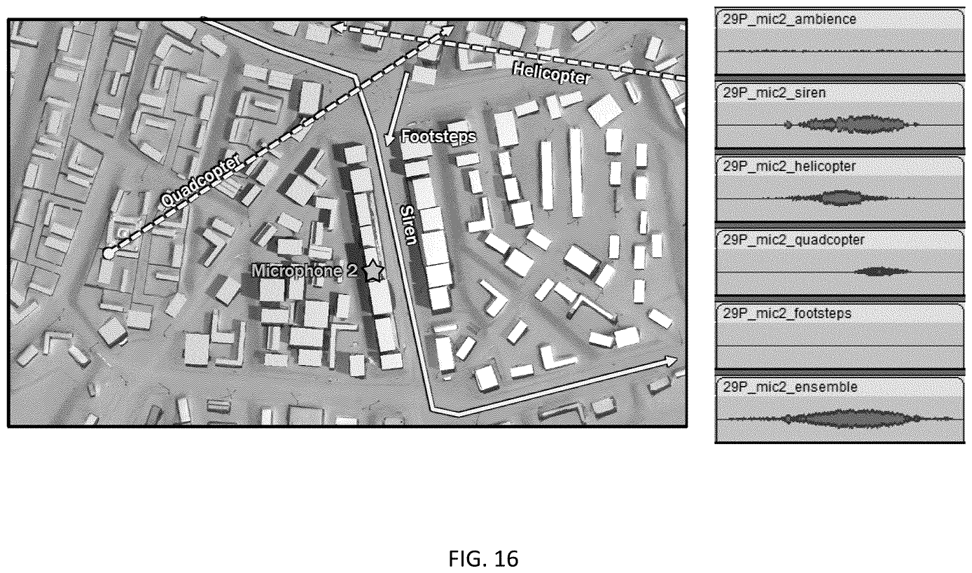

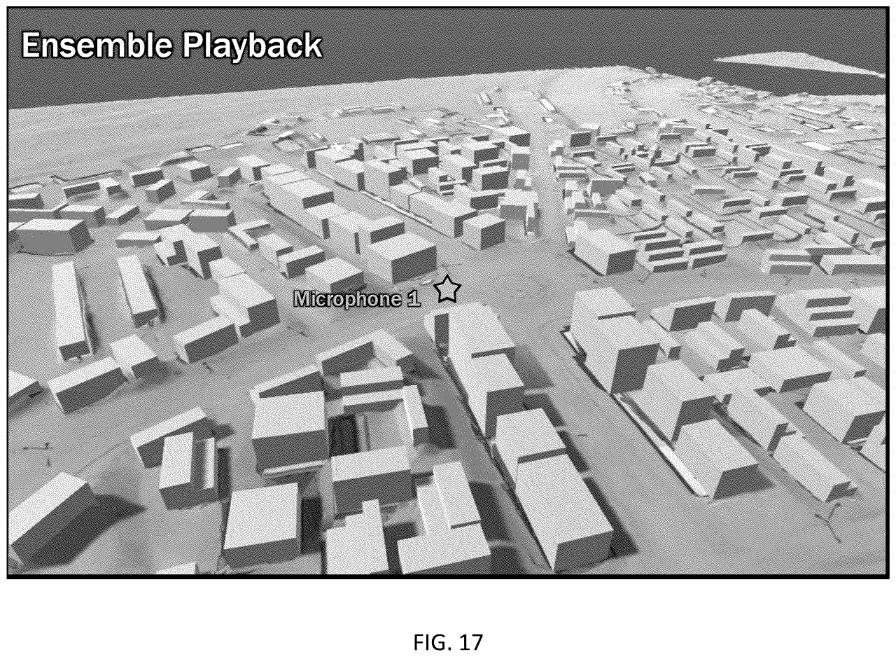

Other example scenario realizations can be seen in FIGS. 15-17, where FIG. 15 illustrates sound recordings recorded from a listening device (Microphone 1) at a first location, and FIG. 16 illustrates sound recordings recorded from a listening device (Microphone 2) at a second location. FIG. 17 illustrates elevation and depth of some of the sound-influence features, like the buildings, roads, objects, etc.

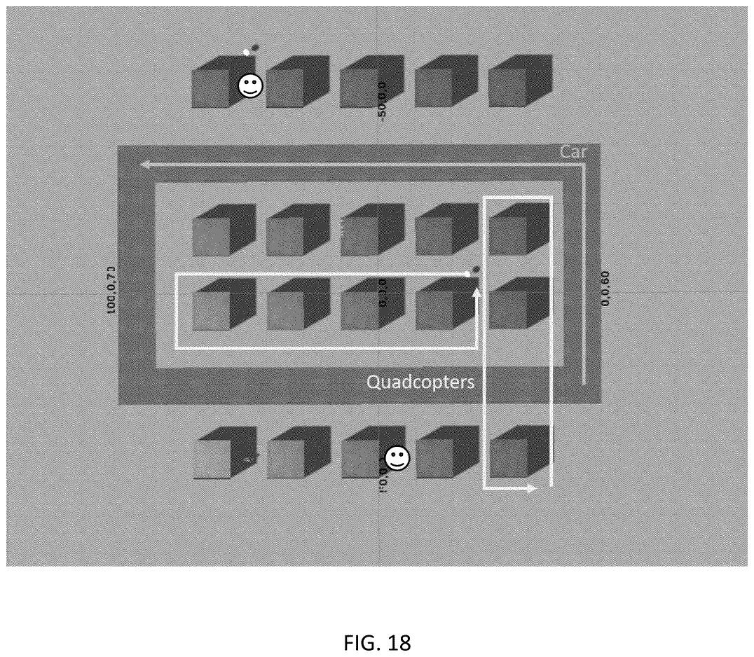

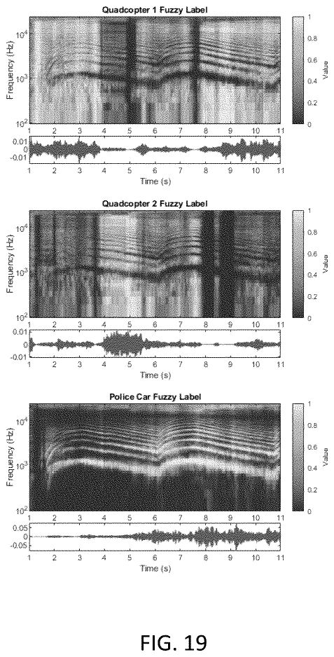

FIGS. 18 and 19 illustrate another example of a scenario realization (FIG. 18) and sound recordings (FIG. 19). These scenarios involve three sound sources (two quadcopters, and a police car) traveling on three different paths through the environment. These sounds are captured, both individually and as an ensemble from two different listening positions. According to some aspects, SANDS provides for fuzzy labeling each individual sound's relative contribution to the ensemble recording. SANDS provides for spectrum-based fuzzy labeling of each individual sound's relative contribution to the overall sound ensemble.

The Spatial Auditory Network Dataset Synthesis (SANDS) tool can model the movement and spatialization of multiple sound sources at once and synthesize a recording of combined sounds from the point of view of a listener position with all the auditory effects of the surrounding environment.

The synthesis tool can replay the scenario with each contributing sound source in isolation to be used in building the fuzzy labeling for that individual sound's contribution to the ensemble recording. This is a key step in building a labeled training set for future machine learning based applications.

The fuzzy labeling quantifies the relative contribution of each individual sound to the overall ensemble recording. This is based upon the spectral components of the spatialized sound in order to capture the unique frequency and time dependent signatures of each sound.

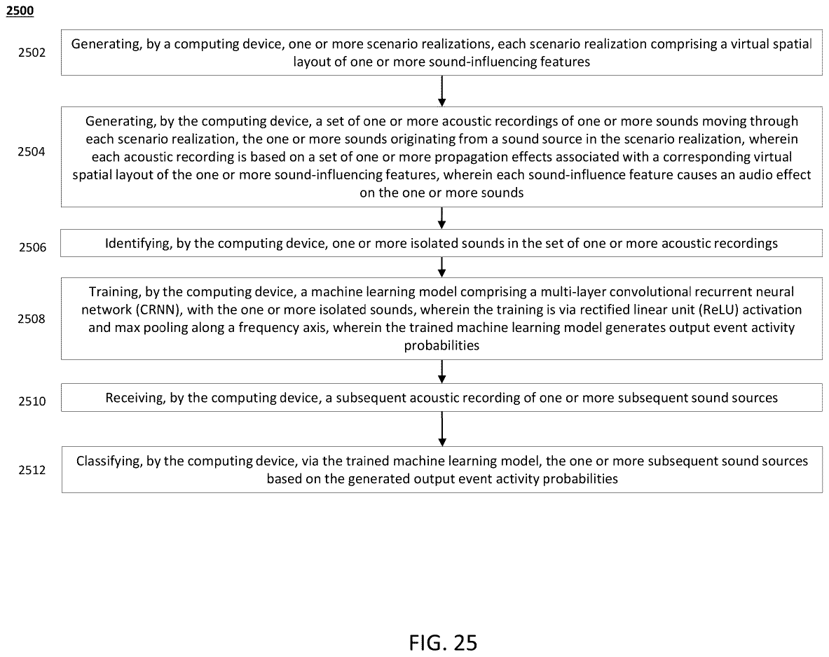

FIG. 25 illustrates an example method 2500, in accordance with one or more disclosed aspects. For example, method 2500 may be a method of training a machine learning artificial intelligence system. Step 2502 may include generating, by a computing device, one or more scenario realizations, each scenario realization comprising a virtual spatial layout of one or more sound-influencing features. Step 2504 may include generating, by the computing device, a set of one or more acoustic recordings of one or more sounds moving through each scenario realization, the one or more sounds originating from a sound source in the scenario realization, wherein each acoustic recording is based on a set of one or more propagation effects associated with a corresponding virtual spatial layout of the one or more sound-influencing features, wherein each sound-influence feature causes an audio effect on the one or more sounds. Step 2506 may include identifying, by the computing device, one or more isolated sounds in the set of one or more acoustic recordings. Step 2508 may include training, by the computing device, a machine learning model comprising a multi-layer convolutional recurrent neural network (CRNN), with the one or more isolated sounds, wherein the training is via rectified linear unit (ReLU) activation and max pooling along a frequency axis, wherein the trained machine learning model generates output event activity probabilities. Step 2510 may include receiving, by the computing device, a subsequent acoustic recording of one or more subsequent sound sources. Step 2512 may include classifying, by the computing device, via the trained machine learning model, the one or more subsequent sound sources based on the generated output event activity probabilities. One or more steps may be repeated, added, modified, and/or excluded.

According to some aspects, one or more disclosed embodiments may have one or more specific applications. For example, a trained machine learning model in accordance with disclosed aspects may be used to facilitate, implement, perform, or the like one or more specific applications. According to some aspects, one or more disclosed aspects may be used to facilitate a water-based operation. In some cases, disclosed aspects may provide information (e.g., identification objects, buildings, people, and the like), and in some cases the information may be used for search & rescue, for safety of navigation, for military situational awareness, for implementing and/or developing a mission route plan associated with operating a vehicle, aircraft, vessel, and/or the like. In some cases, one or more disclosed aspects may be used to facilitate a strategic operation, which can include a defensive tactical operation or naval operation. In some cases, one or more disclosed aspects may be used for security and safety solutions in private or public areas. In some cases, one or more disclosed aspects may be used to plan building layout, such as for city planning.

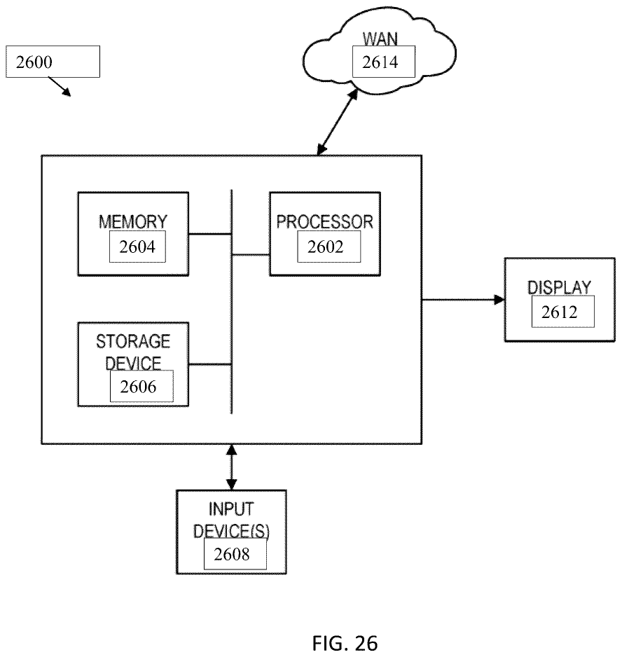

One or more aspects described herein may be implemented on virtually any type of computer regardless of the platform being used. For example, as shown in FIG. 26, a computer system 2600 includes a processor 2602, associated memory 2604, a storage device 2606, and numerous other elements and functionalities typical of today's computers (not shown). The computer 2600 may also include input means 2608, such as a keyboard and a mouse, and output means 2612, such as a monitor or LED. The computer system 2600 may be connected to a local may be a network (LAN) or a wide may be a network (e.g., the Internet) 2614 via a network interface connection (not shown). Those skilled in the art will appreciate that these input and output means may take other forms.

Further, those skilled in the art will appreciate that one or more elements of the aforementioned computer system 2600 may be located at a remote location and connected to the other elements over a network. Further, the disclosure may be implemented on a distributed system having a plurality of nodes, where each portion of the disclosure (e.g., real-time instrumentation component, response vehicle(s), data sources, etc.) may be located on a different node within the distributed system. In one embodiment of the disclosure, the node corresponds to a computer system. Alternatively, the node may correspond to a processor with associated physical memory. The node may alternatively correspond to a processor with shared memory and/or resources. Further, software instructions to perform embodiments of the disclosure may be stored on a computer-readable medium (i.e., a non-transitory computer-readable medium) such as a compact disc (CD), a diskette, a tape, a file, or any other computer readable storage device. The present disclosure provides for a non-transitory computer readable medium comprising computer code, the computer code, when executed by a processor, causes the processor to perform aspects disclosed herein.

Embodiments for training a machine learning model via ray-traced multipath sound propagation been described. Although particular embodiments, aspects, and features have been described and illustrated, one skilled in the art may readily appreciate that the aspects described herein are not limited to only those embodiments, aspects, and features but also contemplates any and all modifications and alternative embodiments that are within the spirit and scope of the underlying aspects described and claimed herein. The present application contemplates any and all modifications within the spirit and scope of the underlying aspects described and claimed herein, and all such modifications and alternative embodiments are deemed to be within the scope and spirit of the present disclosure.

### Credits

This dataset uses these sounds from Freesound:
“beat tune abysses” by donaldtimo (https://freesound.org/s/650865/) licensed under CC BY-NC 4.0 “businxidehmm” by edbIes (https://freesound.org/s/100852/) licensed under CC BY-NC 3.0
“conversation” by mignel2613 (https://freesound.org/s/324783/) licensed under CC0 1.0
“crying newborn baby child” by the_yura (https://fressound.org/s/211527/) licensed under CC0 1.0
“dogs” by oyez (https://freesound.org/s/7383/) licensed under CC BY-NC 3.0
“fairhaven kids playing tag” by briankennemer (https://freesound.org/s/337992/) licensed under CC BY 4.0
“born” by maciejadach (https://freesound.org/s/571322/) licensed under CC0 10
“Jackhammer” by Benbonean (https://fressound.org/8/104998/) licensed under CC BY 4.0
“lawnmower” by E240bpm (https://freesound.org/s/584840/) licensed under CC0 1.0
“motorcycle” by mangowyldex (https://freesound.org/s/144941/) licensed under CC0 1.0
“neighbour drilling into external wall” by VOH (https://freesound.org/s/180029/) licensed under CC BY 4.0
“nzp bmw 1150gs start revs” by Noisemaker (https://freesound.org/s/23219/) licensed under CC0 1.0
“thunderstorm” by rucisko (https://freesound.org/s/164809/) licensed under CC0 1.0
“truck engine running under” by abuurman (https://freesound.org/s/130018/) licensed under CC BY 3.0
“whelen yelp” by Jefflix (https://freesound.org/s/157866/) licensed

### REFERENCES

[1] Sound event detection domestic environments, 2022. https://dcase.community/challenge2022/task-sound-event-detection-in-domestic-environments; Accessed: 2023-00-05.
[2] Frederic Font, Gerard Roma, and Xavier Serra, Freesound technical demo. In Proceedings of the 21st ACM international conference on Multimedia, pages 411-412, 2013.
[3] Diederik P Kingma and Jimmy Ba. Adam: A method for stochastic optimization. arXiv preprint arXiv:1 112.6080, 2014.

[4] Annamaria Mesamos, Toni Heittala, and Tuomas Virtanen. Metrics for polyphonic sound event detection. Applied Sciences, 6(6):162, 2016.
[5] Emre çakir, Giambattista Parascandolo, Toni Heittola, Heikki Huttunen, and Tuomas Virtanen, Convolutional recurami neural networks for polyphonic sound event detection. IEEE/ACM Transactions on Audio, Speech, and Language Processing, 25(6):1291-1303, 2017.

What is claimed is:

1. A method of training a machine learning artificial intelligence system, comprising:
generating, by a computing device, one or more scenario realizations, each scenario realization comprising a virtual spatial layout of one or more sound-influencing features;
generating, by the computing device, a set of one or more acoustic recordings of one or more sounds moving through each scenario realization, the one or more sounds originating from a sound source in the scenario realization, wherein each acoustic recording is based on a set of one or more propagation effects associated with a corresponding virtual spatial layout of the one or more sound-influencing features, wherein each sound-influence feature causes an audio effect on the one or more sounds;
identifying, by the computing device, one or more isolated sounds in the set of one or more acoustic recordings;
training, by the computing device, a machine learning model comprising a multi-layer convolutional recurrent neural network (CRNN), with the one or more isolated sounds, wherein the training is via rectified linear unit (ReLU) activation and max pooling along a frequency axis, wherein the trained machine learning model generates output event activity probabilities;
receiving, by the computing device, a subsequent acoustic recording of one or more subsequent sound sources; and
classifying, by the computing device, via the trained machine learning model, the one or more subsequent sound sources based on the generated output event activity probabilities.

2. The method of claim 1, wherein output of a convolutional layer of the CRNN is stacked and fed into recurrent layers before a forward feed layer with sigmoid activation produces the output event activity probabilities.

3. The method of claim 1, wherein binary event activity predictions are produced by thresholding the output event activity probabilities at 0.5.

4. The method of claim 1, further comprising identifying, in the subsequent acoustic recording, via the trained machine learning AI system, one or more subsequent isolated frequencies.

5. The method of claim 1, wherein the classifying comprises determining a level of correspondence between the one or more subsequent isolated frequencies and the at least one of the isolated sounds.

6. The method of claim 1, wherein the level of correspondence is based on one or more of the generated output event activity probabilities.

7. The method of claim 1, wherein the one or more sound-influence features comprise one or more physical attributes.

8. The method of claim 7, wherein the one or more physical attributes affect sound via Occlusion, Reflection, Transmission, Scattering, Absorption, Reverberation, or Doppler effect.

9. The method of claim 1, wherein the one or more sound-influence features comprises surface type.

10. The method of claim 1, wherein the one or more sound-influence features comprises surface geometry.

11. The method of claim 1, wherein the set of one or more propagation effects comprise ray-traced multipath sound propagation.

12. The method of claim 1, wherein each scenario realization comprises a set of one or more constraints that influence sound propagation.

13. The method of claim 1, wherein the training further comprises training, validating, and testing a machine learning classifier implementation for a sound event detection application.

14. The method of claim 1, further comprising generating a spatialized ensemble sound file for a first scenario realization comprising a plurality of sounds and one or more isolated spatial recordings of respective constituent sound sources of the scenario realization.

15. The method of claim 1, wherein each scenario realization comprises one or more sensors for detecting audio associated with the one or more sounds.

16. The method of claim 1, wherein the one or more scenario realization comprises one or more locations of listeners, sound sources, tracks of sound sources, or ambiance.

17. The method of claim 1, from comprising receiving user input to generate the one or more scenario realizations.

18. The method of claim 17, wherein the user input comprises a human-readable text file that specifies the location of listeners, sound sources, tracks of sound sources, and ambiance.

19. The method of claim 1, wherein each scenario realization comprises sounds sources, motion characteristics, environmental geometry, or environmental acoustic properties.

20. The method of claim 1, further comprising performing a water-based operation based on the classification.

21. The method of claim 1, further comprising performing a military tactical operation based on the classification.
